(19) United States
(12) Patent Application Publication
(10) Pub. No.: US 2006/0119880 A1
(43) Pub. Date: Jun. 8, 2006

(54) Local photo printing

(76) Inventors: Shree A. Dandekar, Round Rock, TX (US); Shannon Christopher Boesch, Austin, TX (US)

Correspondence Address: HAMILTON & TERRILE, LLP, P.O. BOX 203518, AUSTIN, TX, 78720, US

(21) Appl. No.: 11/001,750

(22) Filed: Dec. 2, 2004

(51) Int. Cl. G06F 3/12

(52) U.S. Cl. 358/1.15

(57) ABSTRACT

A method for printing image data from a service provider which includes identifying image data stored by the service provider for printing, transferring the image data to a user information handling system, configuring the user information handling system for printing the image data and automatically printing the image data. Configuring the user information handling system for printing is performed by the service provider.

### BACKGROUND OF THE INVENTION

1. Field of the Invention

The present invention relates to the photo printing and more particularly to photo printing of online content via a local photo printer.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Digital images are stored on various media some that are fixed in location (such as hard disks) and others that can be moved or mailed (such as diskettes, DVDs, or CDROMs). Digital images can also be transferred over communications media such as the internet, local networks, or even a USB (universal serial bus) cable connecting a digital camera to a personal computer. An issue relating to digital images is printing of the digital images onto a presentation media such as a photographic print.

Known system suppliers, such as Dell, Inc, have become very efficient at delivering customers unique photo service offers along with new computer systems. Often a system supplier provides an option for photo services such as photo services during the process of ordering an information handling system. Using the photo service, a customer can instantly upload photographs from a digital camera or computer system or a storage card to the photo service center. Once uploaded, the customer can order prints for any number of photographs.

However, printing digital images presents some challenges. For example, if a customer wishes to print photographs off of the web site that have been shared online by a photo services member, then the customer needs to download the photo onto the user's system, open the photograph with compatible software, format the photo for printer compatibility and then select the printer on which to print the photo. This process can be time consuming and presents a user with a variety of choices.

### SUMMARY OF THE INVENTION

In accordance with the present invention, a process for printing image data from a photo service provider is disclosed. Such a process helps in reducing the number of tasks that the user must complete to print hard copies of images from a photo service.

Such a process generally requires fewer tasks and less time than known photo printing techniques. Such a process also advantageously requires no additional software downloads. The process is more reliable than the known printing techniques. Additionally, the process is less resource intensive for the image service provider.

In one embodiment, the invention relates to a method for printing image data from a service provider which includes identifying image data stored by the service provider for printing, transferring the image data to a user information handling system, configuring the user information handling system for printing the image data and automatically printing the image data. Configuring the user information handling system for printing is performed by the service provider.

In another embodiment, the invention relates to a system for printing image data from a service provider which includes an identifying module, a transferring module, a configuring module and a printing module. The identifying module enables a user to identify image data stored by the service provider for printing. The transferring module transfers the image data to a user information handling system and the configuring module configures the user information handling system for printing the image data. Configuring the user information handling system for printing is performed by the service provider. The printing module causes the image data to be automatically printed.

In another embodiment, the invention relates to an apparatus for printing image data from a service provider which includes means for identifying image data stored by the service provider for printing, means for transferring the image data to a user information handling system, means for configuring the user information handling system for printing the image data, and means for automatically printing the image data. Configuring the user information handling system for printing is performed by the service provider.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a flow chart of a process for printing image data.

FIG. 3 shows an example of a screen presentation a process for printing image data.

### DETAILED DESCRIPTION

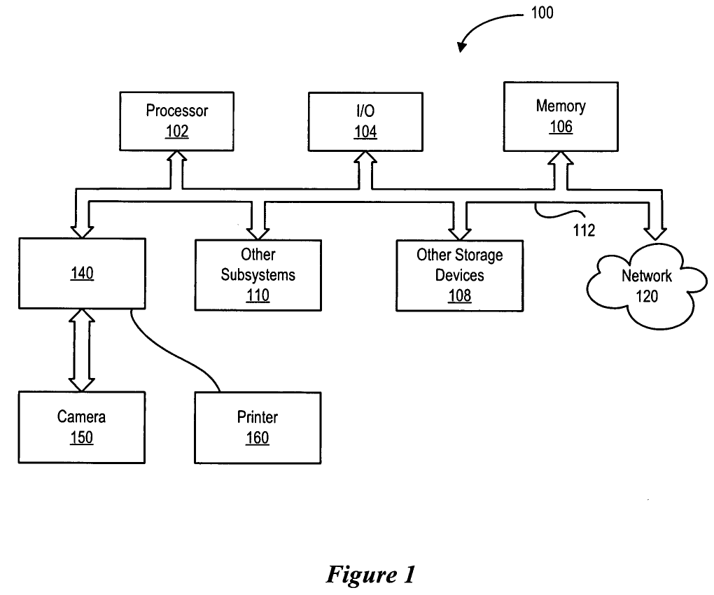

Referring briefly to FIG. 1, a system block diagram of an information handling system 100 is shown. The information handling system 100 includes a processor 102, input/output (I/O) devices 104, such as a display, a keyboard, a mouse, and associated controllers, non volatile memory 106, such as a hard disk and drive, and other storage devices 108, such as a floppy disk and drive and other memory devices, and various other subsystems 110, all interconnected via one or more buses 112. The information handling system 100 may be coupled to a network 120, e.g., via the bus 112. The information handling system may also include a connection device 140 which enables a camera 150 or other type of image data device to be coupled to the information handling system. For example, the information handling system 120 might include a USB or IEEE 1394 type of connector and controller. The connection device 120 also enables a printer 160 to be coupled to the information handling system 100.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include.one or more disk drives, one or more network ports for communicating with external devices as well as various input and output (I/O) devices, such as a keyboard, a mouse, and a video display. The information handling system may also include one or more buses operable to transmit communications between the various hardware components. The information handling system may also be a camera, video recorder or printer.

The camera 150 (e.g., a digital camera) enables users to take pictures and save them in digital (electronic) format. The camera 150 enables users to take pictures (i.e., images), which are saved in memory (not shown) within the camera 150 in a digital (electronic) format. After taking and storing the images, the user can connect the digital camera 108 to the information handling system 100 to upload the digital images to the non-volatile memory 106 of the information handling system 100. Once the digital images are uploaded to the information handling system 100, the user can erase the digital images from the memory of the camera 150 so that the user can take and store additional images using the camera 150. Typically, the camera 150 is connected to the information handling system 100 only while the user is uploading images to the non-volatile memory 106 of the information handling system 100.

Users also can obtain digital images, for example, of film-based prints from a film camera, by providing exposed film into a photo-finishing service, which develops the film to make prints and then scans (or otherwise digitizes) the prints or negatives to generate digital image files. The digital image files then can be transmitted back to the user by e-mail or on a CD-ROM, diskette, or other removable storage medium.

After the digital images are stored on the information handing system 100, a user can perform various operations on digital images. For example, an image viewer application enables viewing the images or a photo editor application enables modifying or touching-up of the images. Also, an electronic messaging (e.g., e-mail) application enables transmission of the digital images to other users.

In addition to viewing the digital images on the display, users often desire to have hard copies (physical prints) made of digital images. Such hard copies can be generated locally by the user using output devices such a printer 160 which may be, e.g., an inkjet printer or a dye sublimation printer. In addition, users can transmit digital images (e.g., either over a computer network or by using a physical storage medium such as a floppy disk) to a photo-finishing service, which can make hard copies of the digital images and send them (e.g., by U.S. Mail or courier service) back to the user.

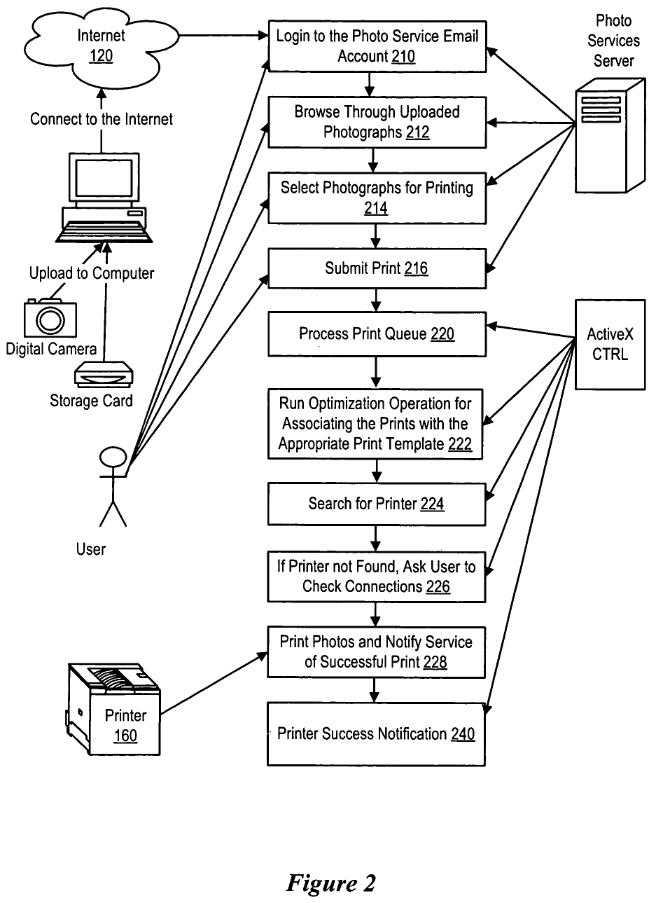

Referring to FIG. 2, a flow chart of a process for printing image data is shown. The process for printing image data provides a single actuation (i.e., one click) solution for printing photos that are stored by a photo service provider. There are a plurality of scenarios in which the process for printing image data may be used. For example, when a customer accesses a photo service account or access an email line to a shared album, the customer can browse through the photo albums, select photos for printing and actuate a print indicia (e.g., a print button on a screen presentation). The process then automatically prints the selected photographs.

Also for example, a customer may transmit a link of a photo album to various recipients such as friends or family for the recipients to view via the photo service. The recipients may browse the photos within the photo album by actuating a link provided by the customer and viewing the photos via the photo service provider. A recipient is then presented with an option for printing the photos either locally via the recipient's printer or remotely via the photo service provider. The photo service provider then accesses the recipient's information handling system to configure the recipient printer for printing the selected photos.

More specifically, a user may desire access to image data from a photo service. When the user accesses the photo service, the user first logs in to a photo service account at step 210. The user may then browse through uploaded photographs at step 212. The user can then select photographs for printing at step 214. The photo service then submits the photograph that is selected for printing to the user computer at step 216.

Next, a middleware application such as an ActiveX control program causes the user computer to process the print and place the print within the print queue of the user's computer at step 220. The process then executes an optimization operation for associating the identified prints with an appropriate print template.

The optimization operation is performed via, e.g., an ActiveX control function. The optimization operation performs a search of the system to detect any manufacturer specific printer drivers as well as a printer version number. Based on this information and the availability of ink within the printer, the optimization operation determines optimum print and color settings (e.g., a desirable dot per inch (dpi) settings) which are desirable for printing the print. Also, based on user preference, the optimization operation determines a size for the print. If no manufacturer printer is detected, then the optimization operation does not offer the optimization option to the user.

The process then searches the user computer for a printer or printers at step 224. If a printer is not located, then the process will notify the user and query the user to check the integrity of any printer connections at step 226. The process then causes the user computer and printer to print the identified photos at step 230. After the prints are generated, a printer success notification is provided to the user as well as to the photo service provider at step 240.

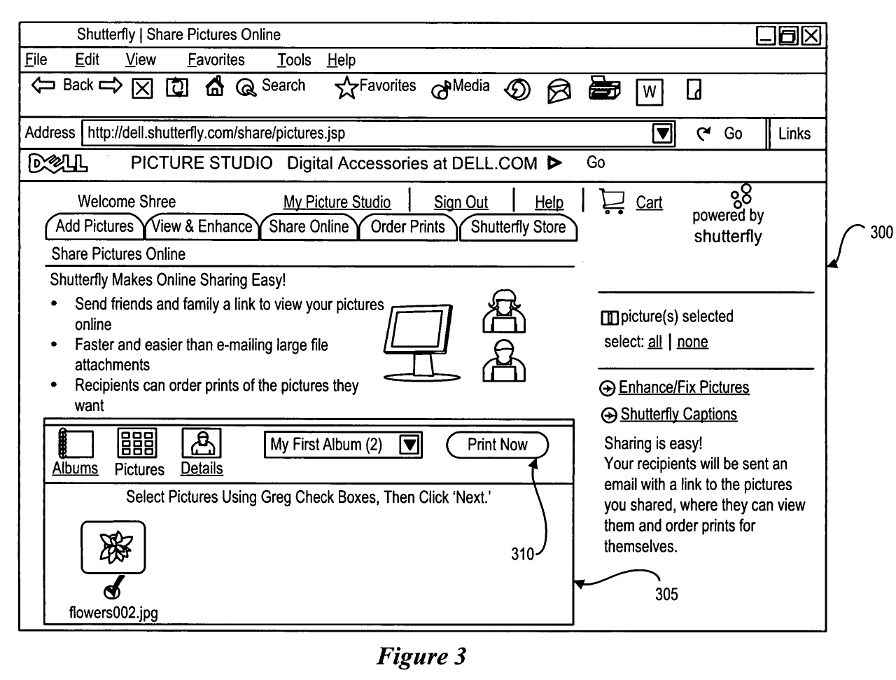

FIG. 3 shows an example of a screen presentation 300 a photo service that includes a process for printing image data. More specifically, the screen presentation 300 includes a selection portion 305 which enables a user to select photos for printing. The screen presentation 300 also includes a print activation button 310 which causes the photo service to initiate the process for printing image data.

### OTHER EMBOBIMENTS

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also for example, other types of peripherals (e.g., cameras, personal digital assistants (PDAs), personal movie players, etc.) are contemplated. These other types of peripherals may also include or provide image data. For example, a video recorder might include motion data for upload or a voice recorder might include sound data for upload.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for printing image data from a service provider comprising:
identifying image data stored by the service provider for printing;
transferring the image data to a user information handling system;
configuring the user information handling system for printing the image data, the configuring being performed by the service provider; and,
automatically printing the image data.

2. The method of claim 1 wherein:
the user information handling system is a user computer.

3. The method of claim 1 wherein:
the user information handling system is a printer.

4. The method of claim 1 wherein:
the configuring is via a middleware application.

5. The method of claim 4 wherein:
the middleware application is an ActiveX control application.

6. The method of claim 4 wherein:
the middleware application is performs an optimization operation, the optimization operation optimizing printing the image data for a particular printer.

7. A system for printing image data from a service provider comprising:
an identifying module, the identifying module enabling a user to identify image data stored by the service provider for printing;
a transferring module, the transferring module transferring the image data to a user information handling system;
a configuring module, the configuring module configuring the user information handling system for printing the image data, the configuring being performed by the service provider; and,
a printing module, the printing module causing the image data to be automatically printed.

8. The system of claim 7 wherein:
the user information handling system is a user computer.

9. The system of claim 7 wherein:
the user information handling system is a printer.

10. The system of claim 7 wherein:
the configuring is via a middleware application.

11. The system of claim 10 wherein:
the middleware application is an ActiveX control application.

12. The system of claim 10 wherein:
the middleware application is performs an optimization operation, the optimization operation optimizing printing the image data for a particular printer.

13. An apparatus for printing image data from a service provider comprising:
means for identifying image data stored by the service provider for printing;
means for transferring the image data to a user information handling system;
means for configuring the user information handling system for printing the image data, the configuring being performed by the service provider; and,
means for automatically printing the image data.

14. The apparatus of claim 13 wherein:
the user information handling system is a user computer.

15. The apparatus of claim 13 wherein:
the user information handling system is a printer.

16. The apparatus of claim 13 further comprising:
a middleware application, the middleware application including the means for configuring.

17. The apparatus of claim 16 wherein:
the middleware application is an ActiveX control application.

18. The apparatus of claim 16 wherein:
the middleware application is performs an optimization operation, the optimization operation optimizing printing the image data for a particular printer.
